(19) United States
(12) Patent Application Publication
(10) Pub. No.: US 2024/0278050 A1
(43) Pub. Date: Aug. 22, 2024

(54) LIFTING EQUIPMENT

(71) Applicant: FICONT INDUSTRY (BEIJING) CO., LTD., Beijing (CN)

(72) Inventors: Tiehui YU, Beijing (CN); Yunfeng TIAN, Beijing (CN)

(21) Appl. No.: 18/651,497

(22) Filed: Apr. 30, 2024

Related U.S. Application Data
(63) Continuation-in-part of application No. PCT/CN2022/085303, filed on Apr. 6, 2022.

(30) Foreign Application Priority Data
Mar. 4, 2022 (CN) 202220463779.0

(51) Int. Cl. A62B 35/00

(52) U.S. Cl. CPC A62B 35/0062; A62B 35/0081; A62B 35/0093

(57) ABSTRACT

A lifting equipment includes a guide rail; a climbing assistant, suitable for ascending and descending along the rail, said climbing assistant having a carriage and a first anti-fall device installed between the said carriage and the said guide rail, and the said first anti-fall device being capable of locking onto the said guide rail when the said carriage experiences weightlessness; a second anti-fall device for installation between the said guide rail and the personnel working on the said carriage, and the said second anti-fall device being capable of locking onto the same guide rail as the said climbing assistant when the personnel on the said carriage become weightless. The first anti-fall device used for the climbing assistant and the second anti-fall device for the personnel are installed on the same guide rail, and allowing the guide rail to be installed in the most optimal position.

### CROSS-REFERENCE TO RELATED APPLICATIONS

This application is a continuation-in-part of PCT international application no. PCT/CN2022/085303, filed on Apr. 6, 2022, which claims priority to Chinese patent application with application Ser. No. 20/222,0463779.0, titled “Lifting Equipment,” filed on Mar. 4, 2022, the content of each is incorporated by reference in its entirety.

### FIELD OF TECHNOLOGY

This application relates to the technical field of elevated work, particularly involving a lifting equipment.

### BACKGROUND

Currently, in industries such as wind power generation and construction, there is a need for high-altitude operations. Especially in the field of wind power generation, working at height and high-altitude transportation are very common. To ensure the safety of personnel working at height, it is essential to install reliable lifting equipment.

In related technologies, lifting equipment includes guide rails for personnel anti-fall devices and guide rails for climbing assistants. The two types of guide rails occupy a considerable amount of space, resulting in inconvenience in use and high costs. Moreover, to install both types of guide rails, at least one of them is inevitably not in the optimal position.

Furthermore, when using the lifting equipment, if a fall occurs, there may be a situation where at least one of the personnel anti-fall device and the carriage anti-fall device of the climbing assistant may not be able to lock in time. This can result in the inability to provide the most reliable protection for the operator.

### SUMMARY

Some disclosed embodiments of this disclosure provide a lifting equipment, including: a guide rail;
a climbing assistant, suitable for ascending and descending along the rail, the said climbing assistant comprises a carriage and a first anti-fall device, the said first anti-fall device is installed between the said carriage and the said guide rail, and the said first anti-fall device is capable of locking onto the said guide rail when the said carriage loses weight;
a second anti-fall device, suitable for installation between the said guide rail and the personnel working on the said carriage, and the said second anti-fall device is capable of locking onto the said guide rail as the said climbing assistant when the personnel on the said carriage become weightless.

According to some exemplary embodiments disclosed herein, the said guide rail includes a first sidewall and a third sidewall arranged in a relative configuration, and a second sidewall connecting the said first sidewall and the said third sidewall, a closing groove being formed between the said first sidewall, the said second sidewall and the said third sidewall, and the said closing groove is used for installing the said first anti-fall device and the said second anti-fall device.

According to some exemplary embodiments disclosed herein, the said guide rail includes a connecting part, and the said connecting part is set with positioning holes, the said positioning holes on the adjacent sections of the said guide rail correspond to each other, and the connecting shafts are connected respectively at both ends to the said positioning holes of the adjacent sections of the said guide rail to fixedly connect the adjacent segments of the guide rail.

According to some exemplary embodiments disclosed herein, the said connecting part includes protuberances formed respectively on the said first sidewall and the said third sidewall, and the said protuberances extend along the length of the said guide rail, and the said carriage includes guiding grooves that form a guiding coordination with the protuberances.

According to some exemplary embodiments disclosed herein, the said first sidewall of adjacent sections of the said guide rail, as well as the said third sidewall of adjacent sections of the said guide rail, are all fixed by connecting members.

According to some exemplary embodiments disclosed herein, the said second sidewall is formed with locking holes, and the said first anti-fall device and the said second anti-fall device are locked into the said locking holes.

According to some exemplary embodiments disclosed herein, the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

According to some exemplary embodiments disclosed herein, the said tachometer wheel and the said centrifugal block are both fixedly mounted on a main shaft, the said tachometer wheel drives the said rotation of the centrifugal block through the said main shaft, the said first cam is fixedly mounted on a transmission shaft, and when the said centrifugal block is open, it connects with the said transmission shaft through a transmission sleeve.

According to some exemplary embodiments disclosed herein, the said first anti-fall device also includes a second anti-fall component, the said second anti-fall component comprises a first locking member hinged on the said carriage, when the said carriage is operating normally, the said first locking member compresses a reset spring, when the said carriage undergoes weightlessness, the said reset spring ejects the said first locking member, causing the said first locking member to lock onto the said guide rail.

According to some exemplary embodiments disclosed herein, the said second anti-fall device includes:
a fixed main body, installed on the said guide rail through a first wheel assembly and moving along the said guide rail, wherein the said first wheel assembly includes a wheel shaft;
a locking member, installed on the said fixed main body, and capable of switching between a locked position and a free position;
a first triggering mechanism, installed on the said fixed main body, the said first
triggering mechanism comprises a transmission component and a driving component, the said transmission component is mounted on the said wheel shaft and rotates with the said wheel shaft, the said transmission component switches between a first position and a second position based on centrifugal force, in the said first position, the said transmission component disengages from the said driving component, and in the said second position, the said transmission component transfers the rotation of the said wheel shaft to the said driving component, causing the said driving component to rotate and move the said locking member to the said locked position.

According to some exemplary embodiments disclosed herein, the said second anti-fall device further includes:
a second triggering mechanism, installed on the said fixed main body, comprising an oscillating bar, the said oscillating bar switches between a reset position and a force-receiving position, in the said reset position, the said oscillating bar drives the said locking member to move to the said locked position.

According to some exemplary embodiments disclosed herein, the said oscillating bar comprises a triggering end and a free end, the said triggering end is connected to the said fixed main body through a second elastic element, in the said reset position, the said second elastic element is in its original state, and in the said force-receiving position, the said second elastic element is compressed, the said free end forms a connecting hole, which is used to connect to the personnel working on the said carriage.

According to some exemplary embodiments disclosed herein, the said second anti-fall device further includes:
a first wheel assembly, mounted on the said fixed main body, for rolling along the said guide rail;
a second wheel assembly, mounted on the said fixed main body, for rolling along an inner support surface of the said guide rail, the said second wheel assembly includes a second wheel pair, with the said second wheel pair connected to a main rotation shaft, the said main rotation shaft is connected to a main rotating element;
a third wheel assembly, mounted on the said fixed main body, for rolling along the said inner support surface of the said guide rail, the said third wheel assembly includes a third wheel pair, with the said third wheel pair connected to a slave rotation shaft;
a linkage component is set between the said main rotation shaft and the said slave rotation shaft.

According to some exemplary embodiments disclosed herein, the said carriage includes a pedal, and the said pedal is set with a load detection component, the said load detection component controls the starting and stopping of the said carriage based on changes in the load on the said pedal.

According to some exemplary embodiments disclosed herein, the said load detection component controls the stopping of the said carriage based on the load on the said pedal being greater than a first set load or less than a second set load, wherein the said first set load is greater than the said second set load.

### BRIEF DESCRIPTION OF THE DRAWINGS

To provide a clearer explanation of the technical solution of the present disclosure, a brief introduction to the accompanying drawings required for the description of the embodiments will be given below. It is evident that the drawings described below are some embodiments of the present disclosure, and for those skilled in the art, additional drawings can be obtained based on these drawings without creative effort.

FIG. 1 is a schematic diagram of the structure of the lifting equipment provided in the embodiments of the present disclosure;

FIG. 2 is the first schematic diagram of the structure of the guide rail in the embodiments of the present disclosure;

FIG. 3 is the second schematic diagram of the structure of the guide rail in the embodiments of the present disclosure;

FIG. 4 is the third schematic diagram of the structure of the guide rail in the embodiments of the present disclosure;

FIG. 5 is the first schematic diagram illustrating the connection relationship between multiple sections of the guide rail in the embodiments of the present disclosure;

FIG. 6 is the second schematic diagram illustrating the connection relationship between multiple sections of the guide rail in the embodiments of the present disclosure;

FIG. 7 is a schematic diagram illustrating the assembly relationship between the second anti-fall device and the guide rail in the embodiments of the present disclosure;

FIG. 8 is a schematic diagram illustrating the assembly relationship between the second anti-fall device and the guide rail in the embodiments of the present disclosure;

FIG. 9 is a schematic diagram illustrating the structure of the first anti-fall component in the embodiments of the present disclosure;

FIG. 10 is a schematic diagram illustrating the structure of the main shaft in the embodiments of the present disclosure;

FIG. 11 is a schematic diagram illustrating the structure of the transmission sleeve in the embodiments of the present disclosure;

FIG. 12 is a schematic diagram illustrating the structure of the first anti-fall device in the embodiments of the present disclosure;

FIG. 13 is a schematic diagram illustrating the installation of the first anti-fall device in the embodiments of the present disclosure;

FIG. 14 is the first schematic diagram illustrating the installation of the second anti-fall component in the embodiments of the present disclosure;

FIG. 15 is the second schematic diagram illustrating the installation of the second anti-fall component in the embodiments of the present disclosure;

FIG. 16 is the first schematic diagram illustrating the installation of the second anti-fall device in the embodiments of the present disclosure;

FIG. 17 is the first schematic diagram illustrating the structure of the second anti-fall device in the embodiments of the present disclosure;

FIG. 18 is the second schematic diagram illustrating the structure of the second anti-fall device in the embodiments of the present disclosure;

FIG. 19 is the third schematic diagram illustrating the structure of the second anti-fall device in the embodiments of the present disclosure;

FIG. 20 is the second schematic diagram illustrating the installation of the second anti-fall device in the embodiments of the present disclosure;

FIG. 21 is the first schematic diagram illustrating a partial structure of the second anti-fall device in the embodiments of the present disclosure;

FIG. 22 is the second schematic diagram illustrating a partial structure of the second anti-fall device in the embodiments of the present disclosure;

FIG. 23 is the third schematic diagram illustrating a partial structure of the second anti-fall device in the embodiments of the present disclosure.

FIG. 24 is the fourth schematic diagram illustrating a partial structure of the second anti-fall device in the embodiments of the present disclosure;

FIG. 25 is the fifth schematic diagram illustrating a partial structure of the second anti-fall device in the embodiments of the present disclosure;

FIG. 26 is the sixth schematic diagram illustrating a partial structure of the second anti-fall device in the embodiments of the present disclosure;

FIG. 27 is the seventh schematic diagram illustrating a partial structure of the second anti-fall device in the embodiments of the present disclosure;

FIG. 28 is a schematic diagram illustrating the structure of the main rotation shaft in the embodiments of the present disclosure.

### REFERENCE NUMERALS

1001. Top wheel; 1002. Ladder; 1004. Traction rope; 1005. climbing assistant; 1051. Carriage; 10511. Pedal; 1006. Drive component; 1007. Electrical control box; 1008. Tensioning device; 1009. Second anti-fall device;

2i. Second anti-fall component; 2i-1. Safety protection body; 2i-2. Reset spring; 2i-3. Hinge shaft; 2i-4. First locking member; 200. First anti-fall device; 004. First anti-fall component; 500. Fasteners; 6. Fixed shaft; 008. First cam; 9. Supporting side plates; 1000. Compression spring; 11. Bearing; 12. Return spring; 13. First fixing screw; 14. First adjustment screw; 15. Top plate; 16. Lug; 17. Tachometer wheel; 18. Elastic retaining ring; 19. Centrifugal block; 2000. Centrifugal spring; 21. Main shaft; 22. Transmission sleeve; 23. Transmission shaft; 24. Bearing pedestal; 25. Bearer supporting bracket; 26. Limiting screw; 27. First through-hole; 28. Second through-hole; 29. Pin holes;

1. First triggering mechanism; 10. First wheel assembly; 101. Wheel; 102. Sliding mounting base; 103. Third spring; 104. Support plate; 105. Driving member; 106. Wheel shaft; 107. First pin-axis; 108. Transmission member; 109. Fixed base; 110. Second pin-axis; 111. First spring; 2. Second triggering mechanism; 20. Oscillating bar; 201. Connecting hole; 202. Acting surface; 3. Second locking member; 301. Second triggering surface; 302. First triggering surface; 303. Positioning surface; 304. Support surface; 4. Core shaft; 5. Fixed body; 501. First limiting surface; 502. Second limiting surface; 503. First mounting hole; 505. Fifth limiting surface; 06. Fourth spring; 7. Second spring; 8. Second adjustment screw;

01. Second wheel assembly; 0101. Slider; 01011. Locking support slider; 01012. Running support slider; 0102. Main rotation shaft; 01021. Second positioning groove; 01022. Third positioning groove; 01023. First reset hole; 0103. Main rotating member; 0104. First pin; 0105. Second pin; 0106. Fifth spring; 0107. Roller; 0108. Installation shaft; 0109. Positioning washer; 0110. Third pair of wheels; 02. Third wheel assembly; 0201. Slave rotation shaft; 02011. Second reset hole; 0202. Third pin; 03. Linkage plate; 0301. Driven holes; 0302. Locking hole; 0303. Active hole; 0304. Guiding surfaces; 04. Unlocking component; 0401. Sliding shaft; 0402. Sixth spring; 0403. Fourth pin; 05. Cover plate; 0501. Third limiting surface; 0502. Fourth limiting surface; 07. Second fixing screw; 08. Guide limiting wheel; 09. Sliding pin; 0601. First positioning groove; 0602. Running limiting surface; 0603. Passive positioning holes; 0604. Active positioning hole;

006. Guide rail; 009. Hook; 0011. Buffer device; 0061. First sidewalls; 0062. Second sidewalls; 0063. Third sidewalls; 0064. Closing groove; 0065. Connecting portion; 00651. Positioning holes; 00652. Connecting shafts; 00653. Protrusion; 0066. Connecting members; 0067. Reinforcing ribs;

00601. Slider channel; 00602. Running limiting surface; 00603. Outer support surface; 00604. Inner support surface; 00605. Guide rail support surface.

### DESCRIPTION OF THE EMBODIMENTS

To clarify the purpose, technical solutions, and advantages of the present disclosure, the following detailed and comprehensive description of the technical solutions in the present disclosure will be provided in conjunction with the accompanying drawings. Clearly, the described embodiments are part of the embodiments of the present disclosure, not all embodiments. Based on the embodiments disclosed herein, all other embodiments obtained by those skilled in the art without creative effort are within the scope of protection of the present disclosure.

According to the lifting equipment in the embodiments of the present disclosure, it can be applied to structures such as wind turbine towers, power transmission towers, and chimneys. Taking a wind turbine tower as an example, the guide rail of the lifting equipment is installed on the ladder of the wind turbine tower. The climbing assistant ascends and descends along the guide rail, thereby transporting workers or items to specific locations on the wind turbine tower.

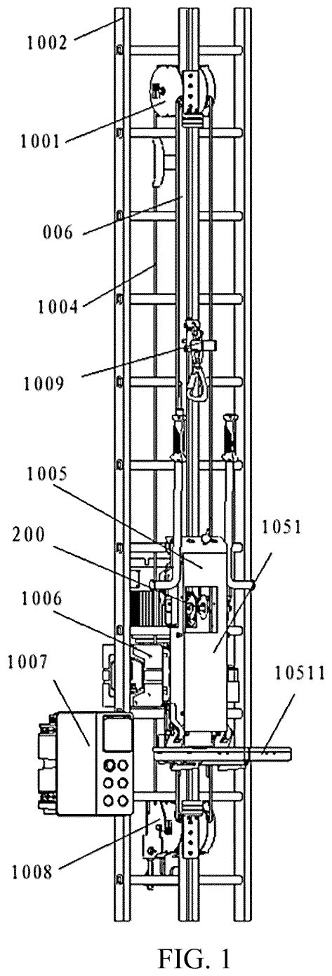

Please refer to FIG. 1. The lifting equipment includes a guide rail 006 and a climbing assistant 1005 that ascends and descends along the guide rail 006. The climbing assistant 1005 comprises a carriage 1051 and a first anti-fall device 200. The carriage 1051 can be used to transport workers or items. The first anti-fall device 200 is installed between the carriage 1051 and the guide rail 006, and it is designed to lock the carriage 1051 to the guide rail 006 when the carriage 1051 loses weight. Here, “carriage 1051 loses weight” refers to all situations where the carriage 1051 is not running at a normal speed or is not normally stopped. The principle of the first anti-fall device 200 locking the carriage 1051 to the guide rail 006 when the carriage 1051 loses weight will be explained in detail later.

According to the embodiments disclosed herein, further referring to FIG. 1, the lifting equipment also includes a second anti-fall device 1009, which is installed between the guide rail 006 and the operating personnel. Generally, the second anti-fall device 1009 is attached to the chest of the operating personnel, although it can also be attached to other parts of the operating personnel. Under normal circumstances, when the operating personnel is standing on the carriage 1051 of the climbing assistant 1005, the second anti-fall device 1009 is subjected to an upward force from the operating personnel and at this time, the second anti-fall device 1009 can move along the guide rail 006 normally. When the operating personnel loses weight, the second anti-fall device 1009 is no longer subject to an upward force, and at this point, it locks onto the guide rail 006. The principle of the first anti-fall device 200 locking the carriage 1051 to the guide rail 006 when the carriage 1051 loses weight will be explained in detail later.

According to the lifting equipment in the embodiments of the present disclosure, the first anti-fall device 200 used by the climbing assistant 1005 and the second anti-fall device 1009 used by personnel are installed on the same guide rail 006. The guide rail 006 can be installed in the most suitable position. In the event of a fall, the first anti-fall device 200 and the second anti-fall device 1009 can achieve synchronous and rapid locking, ensuring the safety of the operating personnel. Because the first anti-fall device 200 and the second anti-fall device 1009 use the same guide rail 006, it occupies less space and reduces the manufacturing cost of the lifting equipment.

Through practical observations, it has been found that the locking distance of the lifting equipment in the embodiments of the present disclosure is less than 200 mm, thereby reliably ensuring the safety of the operating personnel.

According to the embodiments of the present disclosure, the second anti-fall device 1009 is located above the first anti-fall device 200, ensuring that when the operating personnel is standing on the carriage 1051, the second anti-fall device 1009 is attached to the chest of the operating personnel.

According to the lifting equipment in the embodiments of the present disclosure, please refer to FIG. 1, where the guide rail 006 is installed on the ladder 1002. Additionally, the lifting equipment includes a top wheel 1001 and a tensioning device 1008 mounted on the ladder 1002. A traction rope 1004 is wound between the top wheel 1001 and the tensioning device 1008, and the traction rope 1004 is connected to the carriage 1051 of the climbing assistant 1005 to drive the carriage 1051 to ascend or descend. Furthermore, an electrical control box 1007 is also installed on the ladder 1002 to control the drive component 1006 of the lifting equipment. The drive component 1006 controls the ascent, descent, or stoppage of the climbing assistant 1005 based on signals from the electrical control box 1007.

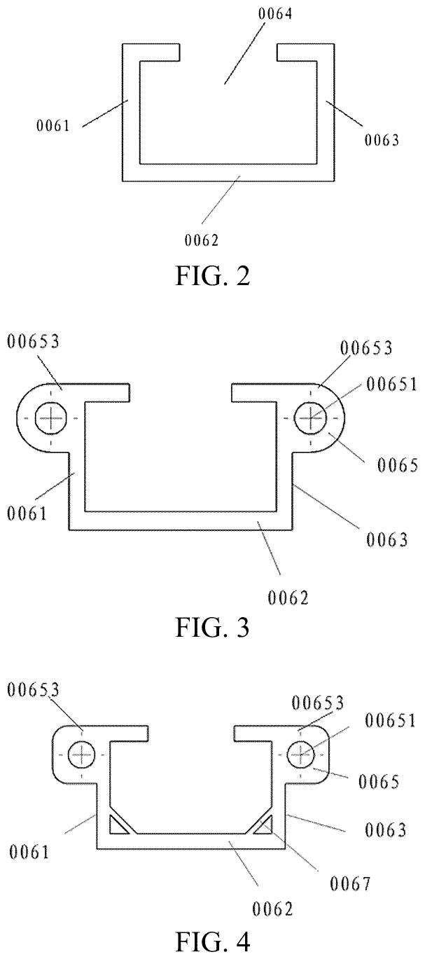

Please refer to FIGS. 2 to 4. According to the lifting equipment in the embodiments of the present disclosure, the guide rail 006 comprises oppositely arranged first sidewall 0061 and third sidewall 0063, as well as the second sidewall 0062 connecting the first sidewall 0061 and the third sidewall 0063. A closing groove 0064 is formed between the first sidewall 0061, the second sidewall 0062, and the third sidewall 0063. Due to the presence of the closing groove 0064 in the guide rail 006, the first anti-fall device 200 and the second anti-fall device 1009 can be installed in the closing groove 0064 to prevent detachment.

In FIG. 2, for the guide rail 006, the first sidewalls 0061 of adjacent sections of the guide rail 006, as well as the third sidewalls 0063 of adjacent sections of the guide rail 006, are fixed by connecting members 0066, as shown in FIG. 6. In the figure, threaded elements pass through the connecting members 0066 and the first sidewall 0061, or threaded elements pass through the connecting members 0066 and the third sidewall 0063, to achieve a reliable fixation between multiple sections of the guide rail 006.

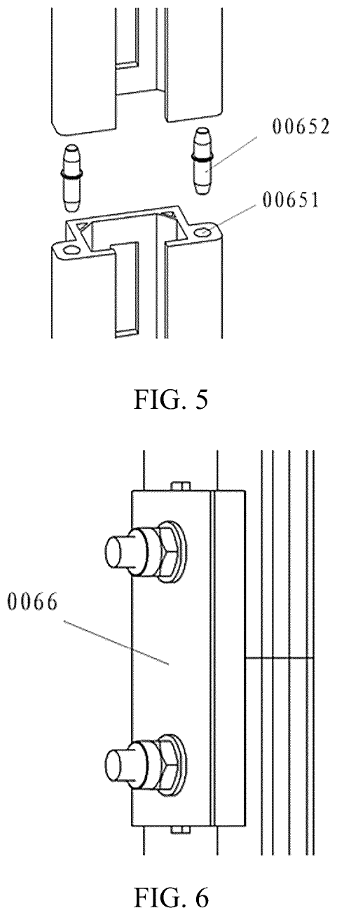

According to the embodiments of the present disclosure, in conjunction with FIGS. 3 to 5, the guide rail 006 also includes a connecting portion 0065. The connecting portion 0065 has positioning holes 00651, where the positioning holes 00651 of adjacent sections of the guide rail 006 correspond to each other, and the connecting shafts 00652 at both ends are respectively connected to the positioning holes 00651 of adjacent sections of the guide rail 006, thereby securely fixing the connection between adjacent sections of the guide rail 006. In this case, the setting of positioning holes 00651 ensures alignment between adjacent guide rails 006, preventing misalignment during the installation of the guide rail 006. This helps avoid situations where the climbing assistant 1005 may get stuck on the guide rail 006 during the operation of the lifting equipment.

In FIGS. 3 and 4, the connecting portion 0065 includes protrusions 00653 formed on the first sidewall 0061 and the third sidewall 0063, and in this case, there are two connecting portions 0065. The guide rail 006 achieves dual positioning through the positioning holes 00651 in the protrusions 00653 located on both sides of the closing groove 0064, ensuring maximum alignment between multiple sections of the guide rail 006. However, the configuration of the connecting portion 0065 is not limited to the illustration; for example, the connecting portion 0065 can also be formed on the third sidewall 0063, and the number of connecting portions 0065 can be one, three, or more than three.

In one embodiment, the protrusions 00653 extend along the length direction of the guide rail 006, and the carriage 1051 includes guide grooves that form a guiding fit with the protrusions 00653 (not shown in the figure). The combination of the protrusions 00653 and guide grooves ensures the reliability of the carriage 1051 during the lifting process. The cross-section of the protrusions 00653 can be square, triangular, polygonal, etc., and the specific structural form is not limited by the illustration.

In FIG. 4, reinforcing ribs 0067 are provided between the first sidewall 0061 and the second sidewall 0062, as well as between the third sidewall 0063 and the second sidewall 0062, to ensure the structural strength of the guide rail 006.

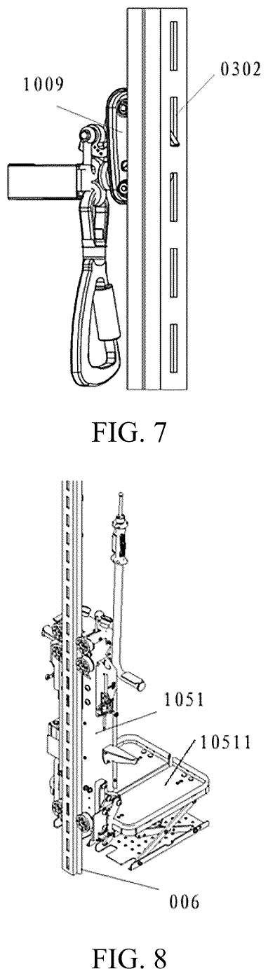

Please refer to FIGS. 7 and 8, where the second sidewall 0062 of the guide rail 006 forms a locking hole 0302. Therefore, in the event of a fall, the first anti-fall device 200 and the second anti-fall device 1009 lock into the locking hole 0302.

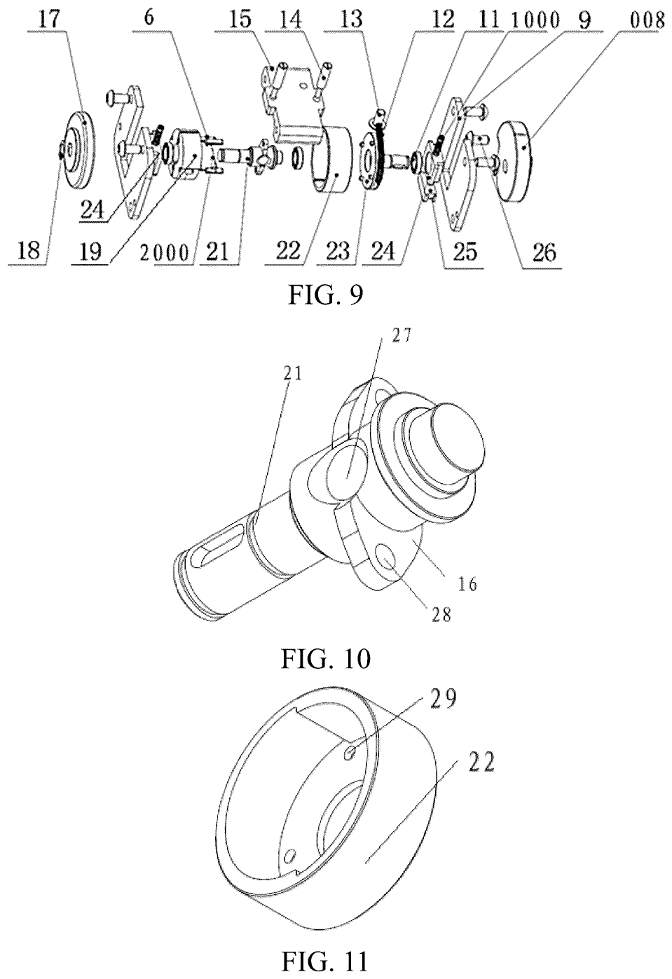

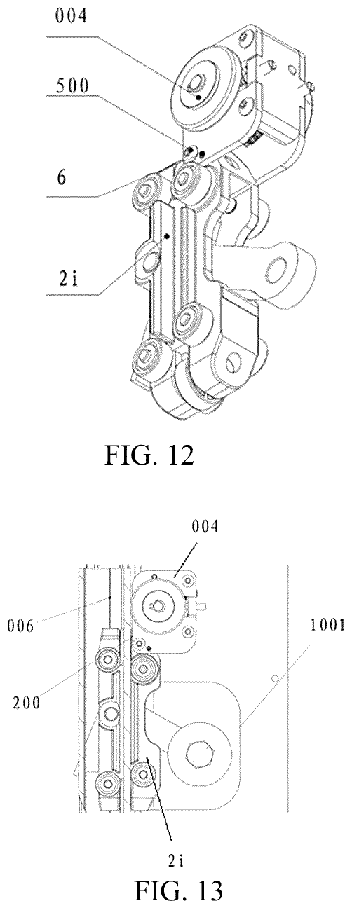

Please refer to FIGS. 9 to 15, where the first anti-fall device 200 includes the first anti-fall component 004 (please see FIGS. 12 and 13). Wherein, please refer to FIG. 9. The first anti-fall component 004 includes a tachometer wheel 17, a centrifugal block 19, and a first cam 008. The centrifugal block 19 is fixed with the tachometer wheel 17 and rotates with the tachometer wheel 17. The centrifugal block 19 is configured such that when the rotational speed of the tachometer wheel 17 is not less than the set speed, the centrifugal block 19 opens and connects with the first cam 008 to drive the first cam 008 to rotate. Wherein, the connection between the centrifugal block 19 and the first cam 008 can be either direct or indirect.

Please refer to FIG. 9. In this embodiment, the first anti-fall component 004 has the tachometer wheel 17 and the centrifugal block 19 fixedly mounted on the main shaft 21, and the tachometer wheel 17 is driven to rotate the centrifugal block 19 through the main shaft 21. Certainly, besides being fixed with the tachometer wheel 17 through the main shaft 21, the centrifugal block 19 can also be directly connected to the tachometer wheel 17 through a centrifugal spring 2000, or it can be connected to the tachometer wheel 17 through any means already disclosed in the prior art. In addition, the first cam 008 is fixedly mounted on the transmission shaft 23, and when the centrifugal block 19 opens, it is connected to the transmission shaft 23 through the transmission sleeve 22. Therefore, when the rotational speed of the tachometer wheel 17 is not less than the set speed, the centrifugal block 19 can drive the transmission shaft 23 to rotate through the transmission sleeve 22, thereby driving the first cam 008 for braking. Certainly, it is not necessary for the connection between the centrifugal block 19 and the transmission shaft 23 to be made through the transmission sleeve 22. Any connection method that can achieve transmission between the centrifugal block 19 and the transmission shaft 23 can be applied between the centrifugal block 19 and the transmission shaft 23. Also, the first cam 008 does not necessarily have to be connected to the transmission shaft 23. For example, the centrifugal block 19 can be directly connected to the first cam 008, so that when the centrifugal block 19 opens, it directly contacts to the first cam 008 and drives the first cam 008 to rotate.

Please refer to FIG. 10. In this embodiment, the main shaft 21 radially opens a first through-hole 27, and the centrifugal spring 2000 passes through the first through-hole 27, with one centrifugal block 19 fixed at each end. In this case, when the rotational speed of the main shaft 21 is within the safe range, the two centrifugal blocks 19 clamp the main shaft 21 under the action of the centrifugal spring 2000. Once the rotational speed of the main shaft 21 exceeds the safe range, the two centrifugal blocks 19 open under the action of centrifugal force. Wherein, the centrifugal blocks 19 can, but do not necessarily have to, be fixed to the centrifugal spring 2000 through a fixed shaft 6. Since the two centrifugal blocks 19 are connected by a single centrifugal spring 2000, this not only simplifies the structure but also ensures that the main shaft 21 is balanced, preventing eccentricity of the main shaft 21.

Referring further to FIG. 10, a lug 16 can be formed on the main shaft 21, and the lug 16 is provided with a second through-hole 28 extending axially along the main shaft 21. When the centrifugal block 19 is connected to the centrifugal spring 2000 through the fixed shaft 6, it can further be hinged through the fixed shaft 6 with the lug 16. For example, a clearance fit can be used between the fixed shaft 6 and the second through-hole 28, allowing the centrifugal block 19 to rotate around the fixed shaft 6 as an axis, pivoting about the second through-hole 28. The fixed shaft 6 here can be an elastic cylindrical pin.

In one embodiment, as shown in FIG. 9 and in conjunction with FIGS. 10 and 11, the transmission shaft 23 is a camshaft, and the centrifugal block 19 needs to be driven to rotate the camshaft through the transmission sleeve 22. The end of the camshaft has a connecting lug extending towards the transmission sleeve 22, and the transmission sleeve 22 is provided with pin holes 29, and the connecting lugs extend into the pin holes 29 on the transmission sleeve 22. To ensure force balance, multiple connecting lugs, for example, four lugs, are evenly distributed at the end of the transmission shaft 23. Certainly, the connection method between the camshaft and the transmission sleeve 22 is not limited to the example given here, as long as the transmission sleeve 22 can drive the camshaft to rotate.

Please refer to FIGS. 9 to 11. In this embodiment, the first anti-fall device 004 further includes a fixed baffle (not shown in the figures) and a bearing pedestal 24. Wherein, the fixed baffle comprises two parallel supporting side plates 9 and a top plate 15 for connecting the two supporting side plates 9; the bearing pedestal 24 is in a quantity of two, with the two bearing pedestals 24 installed between the supporting side plates 9 and the top plate 15, one bearing pedestal 24 for fixing the bearing 11 of the main shaft 21 and the other bearing pedestal 24 for fixing the bearing 11 of the transmission shaft 23. The tachometer wheel 17 and the first cam 008 are located on the outer sides of the two supporting side plates 9.

Wherein, between the two support side plates 9 and between the top plate 15 and the support side plate 9, it is fixedly connected by fasteners 500. Here, the fasteners 500 can be screws. Further example, the first anti-fall device 004 of this embodiment can also be installed on the lifting equipment mentioned below by using fasteners 500.

Furthermore, to limit the rotation angle of the first cam 008, the limiting assembly also includes a limiting screw 26, the limiting screw 26 can cooperate with the first cam 008 and prevent further rotation of the first cam 008.

In this case, the fixed baffle not only isolates and protects the transmission components 108 (including the main shaft 21, transmission shaft 23, centrifugal block 19, and transmission sleeve 22, etc.) located on its inner side but also fixes the main shaft 21 and transmission shaft 23 by installing the shaft 0108 bearing seat 11.

Moreover, to achieve the reliable installation of the tachometer wheel 17, the tachometer wheel 17 is connected to the main shaft 21 through a shaft with an elastic retaining ring 18. That is, an elastic retaining ring 18 for the shaft is provided on the outer side of the tachometer wheel 17, and the elastic retaining ring 18 for the shaft is clamped onto the main shaft 21.

In addition, as seen in FIG. 9, it is observed that the return spring 12 is connected between the transmission shaft 23 and the top plate 15. Thus, the return spring 12 enables the automatic reset of the first cam 008. Wherein, the first end of the return spring 12 can be fixed on the top plate 15 by a first fixing screw 13, and the second end of the return spring 12 can be directly fixed to the outer peripheral surface of the camshaft.

The bottom end of the bearing pedestal 24 is installed on the support side plate 9 through a bearer supporting bracket 25 to ensure the reliability of the installation of the bearing pedestal 24.

The top end of the bearing pedestal 24 is elastically connected to the top plate 15 through an elastic component. In this case, the position of the bearing pedestal 24 can be adjusted by the elastic component to achieve the adjustment of the position of the tachometer wheel 17. For example, when installing the first anti-fall device 004 between the guide rail 006 and the climbing assistant 1005 of the lifting equipment, the position of the bearing pedestal 24 can be adjusted so that the tachometer wheel 17 always reliably moves along the guide rail 006.

At the top of the bearing pedestal 24, there can be a compression spring 1000 connected, and on the top plate 15, there is a first adjustment screw 14 extending toward the compression spring 1000, and the first adjustment screw 14 at least partially enters the compression spring 1000. Here, the compression spring 1000 and the first adjustment screw 14 together form an elastic component between the bearing pedestal 24 and the top plate 15. The position of the bearing pedestal 24 can be adjusted by compressing or releasing the compression spring 1000 using the first adjustment screw 14.

The first anti-fall component 004 in this embodiment is shown in FIG. 12, and the installation of the first anti-fall component 004 can be seen in FIG. 13. The installation of the first anti-fall component 004 is designed to meet the requirement that the tachometer wheel 17 rolls along the guide rail 006, and when the centrifugal block 19 opens, the first cam 008 rotates and presses against the guide rail 006.

In this embodiment of the lifting equipment, due to the direct installation of the first anti-fall component 004 on its climbing assistant 1005, the climbing assistant 1005 is immediately stopped when it exceeds the safe speed. Therefore, this embodiment of the lifting equipment is safe and reliable. It reduces the risk associated with using the traction rope 1004 for over speed control and eliminates the risk of tilting when the climbing assistant 1005 is locked, minimizing the impact damage to the lifting equipment.

The structure after the assembly of the first anti-fall component 004 is shown in FIGS. 12 and 13. In addition, the first anti-fall device 200 also includes a second anti-fall component 2i.

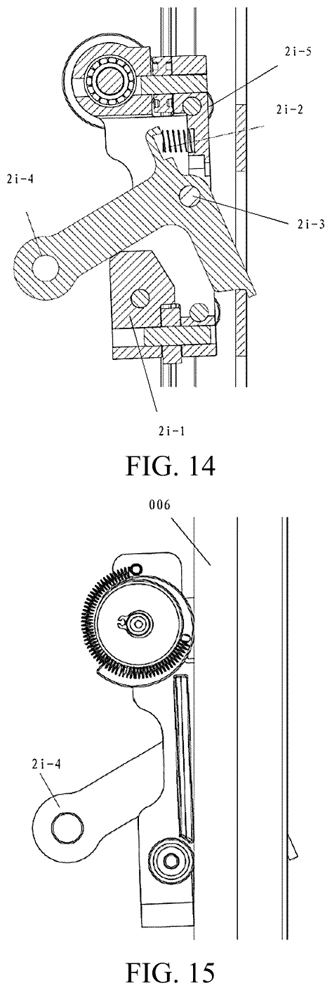

Please refer to FIGS. 14 and 15. The second anti-fall component 2i includes the first locking member 2i-4 hinged on the carriage 1051. When the carriage 1051 is operating normally, the first locking member 2i-4 compresses the reset spring 2i-2. When the carriage 1051 experiences a stalling motion, the reset spring 2i-2 ejects the first locking member 2i-4, causing the first locking member 2i-4 to engage with the locking hole 0302 in the guide rail 006.

In accordance with one of the embodiments disclosed herein, the first locking member 2i-4 is mounted on the safety protection body 2i-1 through the hinge shaft 2i-3. The second anti-fall component 2i is attached to the safety protection body 2i-1 using one end of the reset spring 2i-2, with the other end attached to the first locking member 2i-4, providing a certain elastic force to the first locking member 2i-4. The roller of the second anti-fall component 2i is installed on the safety protection body 2i-1, ensuring smooth sliding of the second anti-fall component 2i along the guide rail 006.

When the carriage 1051 suddenly falls due to the wear of the traction rope 1004 or other reasons, for example, when the traction rope 1004 breaks, causing the carriage 1051 to fall rapidly, the second anti-fall component 2i moves together with the carriage 1051. At this point, the support force of the carriage 1051 on the first locking member 2i-4 disappears. The first locking member 2i-4 of the second anti-fall component 2i, under the elastic force of the reset spring 2i-2, causes the left end of the first locking member 2i-4 to press down, and the right end of the first locking member 2i-4 locks into the locking hole 0302 of the guide rail 006, thereby achieving the fall arrest of the carriage 1051, ensuring the safety of equipment and personnel. When the carriage 1051 is operating normally, under the weight of the safety protection body 2i-1 and the action of the carriage 1051, the left end of the first locking member 2i-4 is lifted, compressing the reset spring 2i-2, and the right end of the first locking member 2i-4 moves away from the locking hole 0302. The second anti-fall component 2i moves uniformly within the guide rail 006 along with the carriage 1051.

Through the above first anti-fall device 200, the carriage 1051 can be locked to the guide rail 006 when the carriage 1051 loses weight.

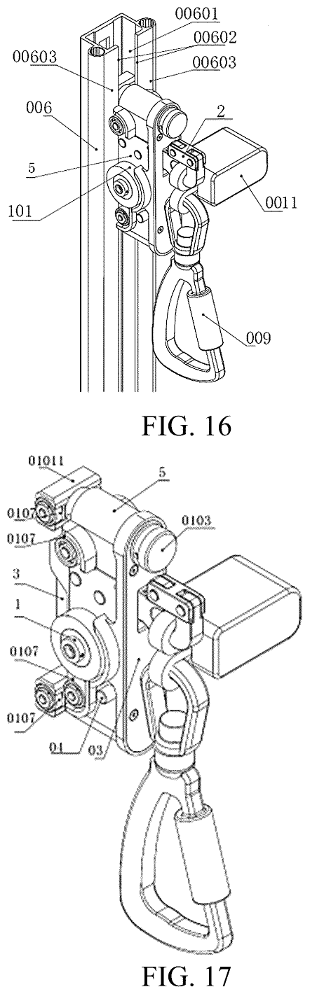

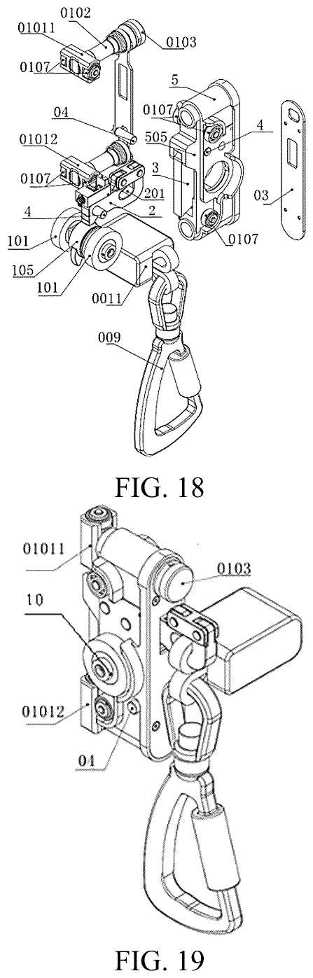

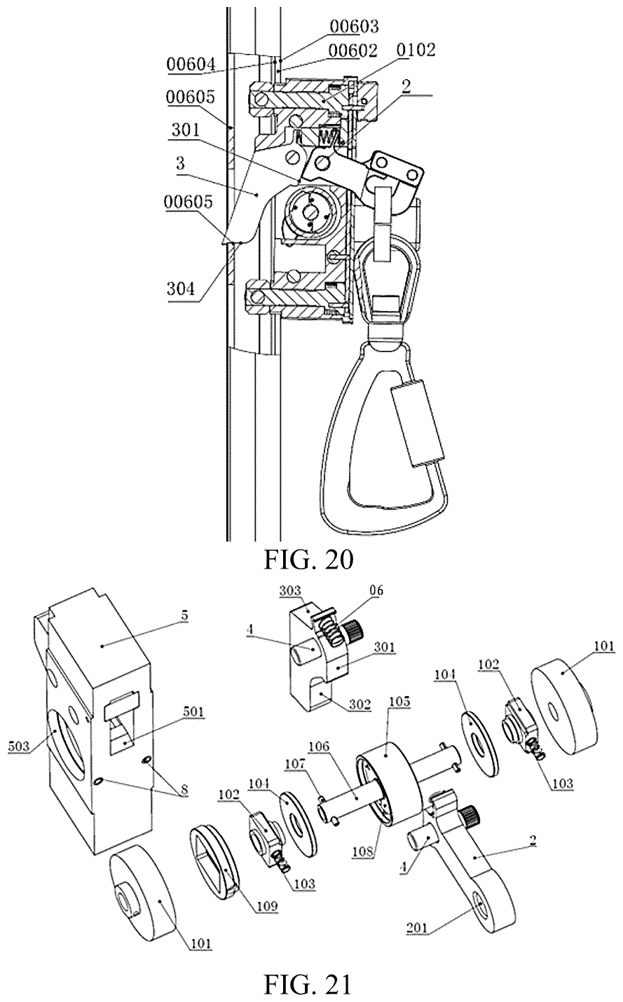

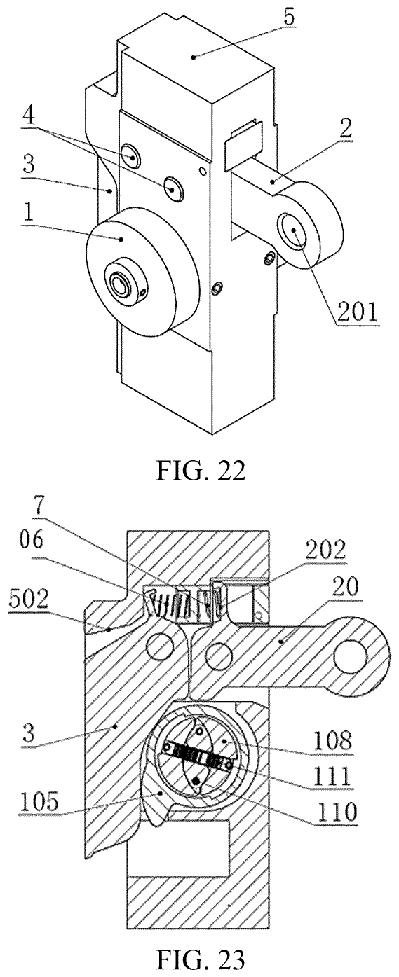

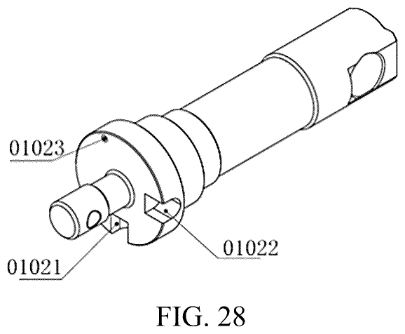

According to the disclosed embodiment, please refer to FIGS. 16 to 28. The lifting equipment also includes the second anti-fall device 1009.

Please refer to FIGS. 16 to 23. The second anti-fall device 1009 includes a fixed body 5, a second locking member 3, and a first triggering mechanism 1. Wherein, the fixed body 5 is installed on the guide rail 006 through the first wheel assembly 10 containing the wheel shaft 106; the second locking member 3 is installed on the fixed body 5 and switches between a locked position and a free position. The first triggering mechanism 1 is installed on the fixed body 5, and the first triggering mechanism 1 includes a transmission member 108 and a driving member 105. The transmission member 108 is installed on the wheel shaft 106 and rotates with the wheel shaft 106, and the transmission member 108, influenced by centrifugal force (as the transmission member 108 rotates with the wheel shaft 106 and is thus subject to centrifugal force), switches between the first position and the second position. In the first position, the transmission member 108 disengages from the driving member 105, and in the second position, the transmission member 108 transfers the rotation of the wheel shaft 106 to the driving member 105. The driving member's 105 rotation drives the second locking member 3 to move to the locked position.

The transmission member 108 of the first triggering mechanism 1 is mounted on the wheel shaft 106 and rotates with the wheel shaft 106, and as the wheel shaft 106 rotates, the speed of the transmission member 108 varies, consequently, the centrifugal force acting on the transmission member 108 also varies. When the rotation speed of the wheel shaft 106 exceeds the set speed, the transmission member 108, under the action of centrifugal force, moves to the second position, then transfers the rotation of the wheel shaft 106 to the driving member 105, and the driving member 105 drives the second locking member 3 to the locked position. Thus, this type of second anti-fall device 1009 achieves automatic locking of the second anti-fall device 1009 by monitoring the rotation speed of the wheel shaft 106. For example, in the event of an accidental fall, the wheel shaft 106 will have a higher rotation speed, causing the transmission member 108 to move toward the driving member 105 under the action of centrifugal force. The wheel shaft 106 drives the driving member 105 to move together, thereby driving the second locking member 3 to the locked position, ensuring safety during use.

Whereas the condition “the transmission member 108 is installed on the wheel shaft 106” refers to the situation where the transmission member 108 can rotate with the wheel shaft 106. For example, an opening can be arranged in the wheel shaft 106, allowing at least a portion of the transmission member 108 to be positioned within the opening. One more example, the transmission member 108 can be mounted on the outer surface of the wheel shaft 106.

According to the disclosed embodiment, the transmission member 108 is installed on the wheel shaft 106 through the first elastic element. In the first position, the first elastic element is in its original state, while in the second position, the first elastic element is stretched.

Please refer to FIGS. 16 to 23. In this embodiment of the second anti-fall device 1009, the transmission member 108 is the triggering block, and multiple triggering blocks are connected by the first elastic element (the first spring 111). In the first position, the first elastic element is in its original state; in the second position, the first elastic element is stretched. The driving member 105 is the driving cam, and the triggering block is set inside the driving cam, the triggering block forms a limited part. In the second position, the limited part limits fit with the inner surface of the driving cam, and the second locking member 3 is a locking block, and the locking block forms a locking block first triggering surface 302, the driving cam forms a cam triggering surface, thus the driving cam acts on the locking block first triggering surface 302 through the cam triggering surface, driving the locking block to rotate. The locking block forms a positioning surface 303, so when the locking block moves to the locking position, the positioning surface 303 of the locking block cooperates with the second limiting surface 502 on the fixed body 5 (the first limiting surface 501 will be mentioned later when describing the second triggering mechanism 2).

In one embodiment, there are two transmission members 108, and the first elastic element between the two transmission members 108 is the first spring 111. In normal conditions, the first spring 111 is in its original state. One end of the first spring 111 is connected to one of the transmission members 108, and the other end is connected to the other transmission member 108, and both transmission members 108 are installed on the outer surface of the wheel shaft 106. When the speed of the wheel shaft 106 exceeds the set speed, under the action of centrifugal force, the two transmission members 108 tend to move away from the axis of the wheel shaft 106, causing the first spring 111 to stretch. When the transmission members 108 move to the second position, there is a limiting fit between the transmission members 108 and the inner surface of the driving cam, allowing the wheel shaft 106 to transmit motion to the driving cam through the transmission members 108.

In one embodiment, as shown in FIG. 21, the wheel 101 of the first wheelset is installed on the wheel shaft 106 through the first pin-axis 107, the transmission member 108 is installed on the wheel shaft 106 through the second pin-axis 110, and the driving cam is installed on the wheel shaft 106 through the support plate 104 and the sliding mounting base 102. The sliding mounting base 102 at one end of the wheel shaft 106 is installed on the fixed base 109 and then mounted on the first mounting hole 503 of the fixed main body 5, and the sliding mounting base 102 at the other end of the wheel shaft 106 is installed on the second mounting hole (No display in the figure. Located on the opposite side of the first mounting hole 503 and communicating with it.) of the fixed main body 5.

Certainly, the specific structures of the transmission component 108, driving component 105, and the second locking component 3 are not limited to the examples provided here. For instance, the transmission component 108 could also be a transmission shaft installed on the wheel shaft 106, when the rotational speed of the wheel shaft 106 exceeds the set speed, the transmission shaft, under the influence of centrifugal force, moves towards the driving component 105. The transmission shaft and the driving component 105 engage in a limiting fit, thereby achieving the objective of transmitting the rotation of the wheel shaft 106 to the driving component 105. Alternatively, the transmission component 108 could also be a transmission block, and there could be two transmission blocks, as shown in FIGS. 21 and 23. Wherein, when the transmission component 108 is a transmission block, the shape and quantity of the transmission blocks can also vary and are not limited to the illustrations. For example, the number of transmission blocks could be one, three, or any arbitrary number. In addition, the driving component 105 does not necessarily have to be a driving cam; it just needs to follow the rotation of the wheel shaft 106 when the transmission component 108 is in the second position, driving the second locking component 3 to the locked position. Similarly, the second locking component 3 does not necessarily have to take the form of a locking block; it just needs to switch between the locked position and the free position and be able to lock the second anti-fall device 1009 to the guide rail 006 when in the locked position.

According to the disclosed embodiments, please refer to FIGS. 16 to 23. The second anti-fall device 1009 also includes a second triggering mechanism 2. The second triggering mechanism 2 is installed on the fixed main body 5 and comprises an oscillating bar 20. The oscillating bar 20 switches between the reset position and the force-receiving position. In the reset position, the oscillating bar 20 drives the second locking member 3 to move to the locking position.

Specifically, under normal circumstances, the oscillating bar 20 is directly or indirectly suspended on the operating personnel with the second anti-fall device 1009 under the influence of gravity. At this time, the oscillating bar 20 does not exert force on the second locking member 3. In the event of weightlessness, when the gravitational force acting on the oscillating bar 20 disappears, the oscillating bar 20 will exert force on the second locking member 3. There is a limiting cooperation between the oscillating bar 20 and the first limiting surface 501 of the fixed main body 5. The oscillating bar 20 applies force to the second triggering surface 301 of the lock block, causing the second locking member 3 to move to the locking position.

Thus, the second anti-fall device 1009 with the above-mentioned first triggering mechanism 1 and second triggering mechanism 2, possesses two independent and non-interfering triggering mechanisms, which ensures the safety and reliability of the second anti-fall device 1009.

According to the disclosed embodiment, the oscillating bar 20 comprises a triggering end and a free end. The triggering end is connected to the fixed main body 5 via the second elastic element. In the reset position, the second elastic element is in its original state, while in the force-receiving position, the second elastic element is compressed.

According to the disclosed embodiment, the free end forms a connecting hole 201, and the connecting hole 201 is used to connect the buffer device 0011. The second locking member 3 is a locking block, and the locking block has a lock block second triggering surface 301 that cooperates with the triggering end.

Additionally, at the triggering end of the oscillating bar 20, there is an acting surface 202. One end of the second elastic element is connected to the fixed main body 5, and the other end is connected to the acting surface 202. Under normal circumstances, the gravitational force of the second anti-fall device 1009 exerts force on the oscillating bar 20 to lift the free end of the oscillating bar 20 upward. At this point, the acting surface 202 compresses the second elastic element, and the triggering end and the second locking member 3 are independent of each other. In the event of an accidental fall, when the oscillating bar 20 is no longer under the gravitational force of the second anti-fall device 1009, then in this compressed state, the second elastic element exerts force on the oscillating bar 20, causing the oscillating bar 20 to rotate clockwise, and drives the second locking member 3 to rotate clockwise to the locking position.

In one embodiment, the second elastic element is the second spring 7. However, in this application, all elastic elements, including the second elastic element, are not limited to the use of spring structures, other structures with deformation and reset functions can also be used.

Please refer to FIGS. 16 to 23. The second locking member 3 is connected to the fixed main body 5 through the fourth elastic element, and the fourth elastic element can, but is not limited to, be the fourth spring 06. Under normal circumstances, the second locking member 3 is connected to the fixed main body 5 through the fourth spring 06. When the fourth spring 06 is in its original state, the second locking member 3 is in the free position. This free position is relative to the locking position, meaning that when the second locking member 3 is in the free position, it does not affect the movement of the second anti-fall device 1009. When the second locking member 3 is driven by the above-mentioned cam or oscillating bar 20, the second locking member 3 moves to the locking position, then the second locking member 3 compresses the fourth spring 06.

The second locking member 3 and the oscillating bar 20 are both mounted on the fixed main body 5 through the core shaft 4. Therefore, the second locking member 3 and the oscillating bar 20 each rotate around the core shaft 4 as the central axis.

Please refer to FIGS. 16 to 28. The second anti-fall device 1009 also includes the first wheel assembly 10. Wherein, the first wheel assembly 10 is mounted on the fixed main body 5 and is designed to roll along the outer support surface 00603 of the guide rail 006 (without excluding the possibility of the first wheel assembly 10 can be rolling at other positions along the guide rail 006). The first wheel assembly 10 comprises a first pair of wheels, the first pair of wheels include the above wheel shaft 106 and the wheel 101 mounted on the wheel shaft 106. The wheel 101 is in constant contact with the outer support surface 00603, enabling the monitoring of the operating speed. The second anti-fall device 1009 achieves locking of the second anti-fall device 1009 by the contact between the support surface 304 of the lock block of the second locking member 3 and the support surface of the guide rail 006.

The second anti-fall device 1009 in this disclosed embodiment ensures the safety of construction workers in the event of a fall, as described above.

In one embodiment, the wheel shaft 106 is mounted on the fixed main body 5 through a sliding mounting base 102. The sliding mounting base 102 is connected to the fixed main body 5 via a third elastic element. The fixed main body 5 is equipped with a threaded fastening device, the threaded fastening device is used to adjust the state of the third elastic element. Specifically, when the threaded fastening device rotates, the state of the third elastic element changes, thereby driving the sliding mounting base 102 to slide. When the sliding mounting base 102 slides, it moves the wheel shaft 106 closer to or farther away from the mounting surface of the fixed main body 5. Here, the mounting surface of the fixed main body 5 refers to the surface facing the outer support surface 00603. Wherein, when the wheel shaft 106 is closer to the mounting surface of the fixed main body 5, it ensures that when the fixed main body 5 is installed on the guide rail 006, the wheel 101 on the wheel shaft 106 is more tightly pressed against the outer support surface 00603 of the guide rail 006. When the wheel shaft 106 moves away from the mounting surface of the fixed main body 5, it ensures that when the fixed main body 5 is installed on the guide rail 006, there is no interference between the wheel 101 on the wheel shaft 106 and the outer support surface 00603 of the guide rail 006.

Therefore, by adjusting the threaded fastening device, it can ensure a better fit between the wheel 101 on the wheel shaft 106 and the outer support surface 00603 of the guide rail 006, ensuring that the wheel 101 can roll along the outer support surface 00603.

In accordance with one embodiment disclosed herein, the threaded fastening device is the second adjustment screw 8, and the third elastic element is the third spring 103 with adjustment functionality. The second adjustment screw 8 is mounted on the fixed main body 5. By compressing the third spring 103 through the second adjustment screw 8, the position of the wheel shaft 106 is adjusted, ensuring that the wheel 101 of the first pair is in constant contact with the guide rail 006 in real time. When the first pair of wheels rotate, the wheel shaft 106 also rotates, driving the transmission component 108 to rotate. Once the centrifugal force of the transmission component 108 exceeds the set value, the transmission component 108 moves towards the second cam 105 and forms a limiting cooperation with the inner surface of the second cam 105, which causes the wheel shaft 106 to rotate the second cam 105 through the transmission component 108, ultimately driving the second locking member 3 to move to the locking position. The second cam is the driving cam 105. Therefore, this ensures that the wheel 101 of the first pair of wheels is in contact with the guide rail 006, achieving the purpose of monitoring the operating speed of the second anti-fall device 1009. When the sliding speed of the second anti-fall device 1009 exceeds the set value, the second cam 105 triggers the movement of the second locking member 3 to the locking position, thereby locking the second anti-fall device 1009 on the guide rail 006.

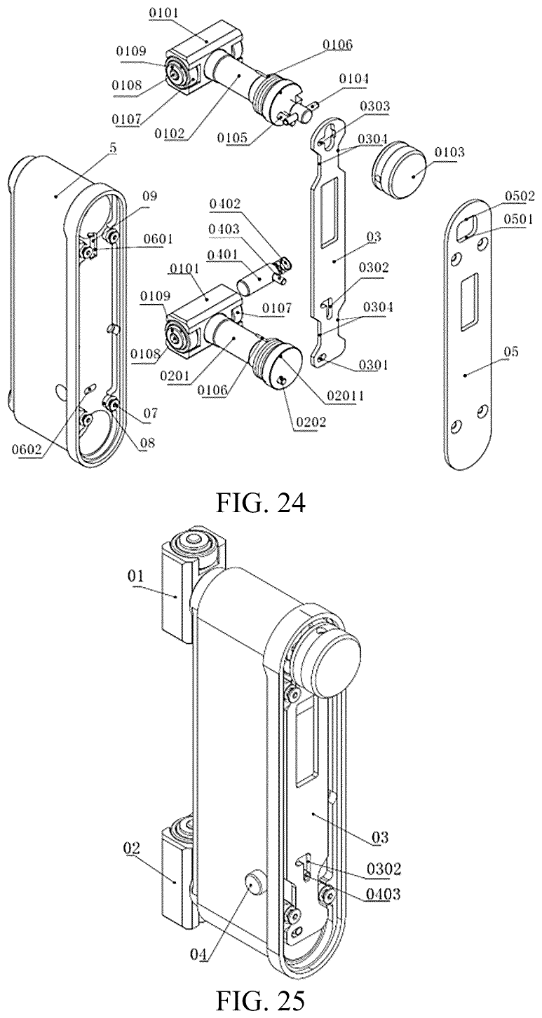

In accordance with the disclosed embodiment, please refer to FIGS. 24 to 28. The second anti-fall device 1009 also includes the second wheel assembly 01 and the third wheel assembly 02. The second wheel assembly 01 is mounted on the fixed main body 5 and is designed to roll along the inner support surface 00604 of the guide rail 006. The second wheel assembly 01 comprises a second pair of wheels, the second pair of wheels is the roller 0107, and the second pair of wheels 0107 is connected to the main rotation shaft 0102, and the main rotation shaft 0102 is connected to the main rotating member 0103. The third wheel assembly 02 is also mounted on the fixed main body 5 and is designed to roll along the inner support surface 00604 of the guide rail 006. The third wheel assembly 02 comprises a third pair of wheels 0110, and the third pair of wheels 0110 is connected to the slave rotation shaft 0201. A linkage component 03 is set between the main rotation shaft 0102 and the slave rotation shaft 0201.

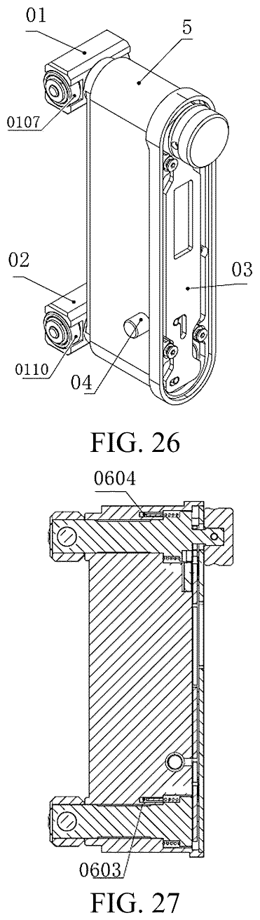

Therefore, the second anti-fall device 1009 in this disclosed embodiment, when rotating the main rotating member 0103, the main rotating member 0103 will drive the main rotation shaft 0102 to rotate, thereby causing the second pair of wheels 0107 to rotate as a whole. Once the main rotation shaft 0102 rotates, it will drive the slave rotation shaft 0201 to rotate through the linkage component 03, thereby causing the third pair of wheels 0110 to rotate. Consequently, during the installation process of the second anti-fall device 1009, it is only necessary to rotate the main rotating member 0103 to transition the state of the second anti-fall device 1009 from the configuration shown in FIG. 26 to the configuration shown in FIG. 25, facilitating the installation of the second anti-fall device 1009. Similarly, when disassembling the second anti-fall device 1009, it is also only necessary to rotate the main rotating member 0103.

It should be noted that, although the drawings illustrate the case where there is only one third wheel assembly 02, with one slave rotation shaft 0201, it is evident that the number of third wheel assemblies 02 is not limited by the example given here, and therefore, the number of slave rotation shafts 0201 is not restricted.

Please refer to FIGS. 24 to 28. The main rotating member 0103 is connected to the main rotation shaft 0102 through the first pin 0104. The linkage component 03 is the linkage plate 03. The main rotation shaft 0102 is connected to the linkage plate 03 through the second pin 0105, and the slave rotation shaft 0201 is connected to the linkage plate 03 through the third pin 0202. On the fixed main body 5, there is a guide limiting wheel 08 for the linkage plate 03. The guide limiting wheel 08 is used to restrict the lateral movement of the linkage plate 03 and to guide its longitudinal movement.

In the phrase “The guide limiting wheel 08 is used to restrict the lateral movement of the linkage plate 03 and guide its longitudinal movement”, the “longitudinal” refers to the direction of extension of the guide rail 006, while “lateral” refers to the width direction of the guide rail 006, which is perpendicular to the longitudinal direction. When the main rotating member 0103 drives the main rotation shaft 0102 to rotate, the second pin 0105 also rotates. Since the linkage plate 03 only moves longitudinally, when the second pin 0105 drives the longitudinal movement of the linkage plate 03, it inevitably undergoes lateral movement relative to the linkage plate 03. Therefore, on the linkage plate 03, there are active holes 0303 extending laterally. One end of the second pin 0105 is mounted on the main rotation shaft 0102, while the other end is located in the active hole 0303, connecting the linkage plate 03 through the active hole 0303. Similarly, on the linkage plate 03, there are driven holes 0301 extending laterally, and the third pin 0202 connects the linkage plate 03 through the driven hole 0301.

In one embodiment, there are four guide limiting wheels 08, and they are installed on the fixed main body 5 through the second fixing screws 07. The linkage plate forms guiding surfaces 0304, and the interaction between the guide limiting wheels 08 and guiding surfaces 0304 ensures the longitudinal movement of the linkage plate 03. It is worth noting that the guide limiting wheels 08 are not a mandatory structure, and in the case of having guide limiting wheels 08, their quantity and distribution can be adjusted as needed.

In one embodiment, the linkage plate 03 is equipped with an L-shaped locking hole 0302, which includes a horizontal hole segment and a vertical hole segment. On the fixed main body 5, there is a fourth pin 0403 that can move along the horizontal hole segment. When the fourth pin 0403 is positioned in the horizontal hole segment, the linkage plate 03 is locked. When the fourth pin 0403 is positioned in the vertical hole segment, the linkage plate 03 is free to move longitudinally.

According to the embodiment of this disclosure, the second anti-fall device 1009 includes an unlocking component 04, the unlocking component 04 comprises the aforementioned fourth pin 0403, and also comprises a sliding shaft 0401 and a sixth spring 0402. The unlocking component 04 is connected to the sliding shaft 0401 by having the fourth pin 0403 pass through the sliding hole 0602 on the fixed main body 5, by pressing the sliding shaft 0401, the unlocking component 04 can compress the sixth spring 0402, causing the fourth pin 0403 to move to the longitudinal hole segment of the locking hole 0302. In this position, the rotating main member 0103 can lift and lower the linkage plate 03. However, when the fourth pin 0403 is in the horizontal hole segment of the locking hole 0302, the linkage plate 03 cannot move up or down, preventing the main rotating member 0103 from rotating.

According to the embodiment of this disclosure, the second anti-fall device 1009 includes a limiting mechanism. The limiting mechanism is used to restrict the rotation of the main rotating shaft 0102 between two extreme positions. In one extreme position, the main rotating shaft 0102 is longitudinally oriented, while in the other extreme position, the main rotating shaft 0102 is transversely oriented. Here, “longitudinally” and “transversely” respectively refer to the extension direction of the guide rail 006 and the width direction of the guide rail 006. When the main rotating shaft 0102 is longitudinally oriented, as shown in FIG. 25, it is convenient for the assembly and disassembly of the second anti-fall device 1009. When the main rotating shaft 0102 is transversely set, please refer to FIG. 26 for the configuration of the second anti-fall device 1009. At this point, the second anti-fall device 1009 can be securely fixed to the guide rail 006, preventing the second anti-fall device 1009 from detaching from the guide rail 006.

Please refer to FIG. 24. According to the disclosed embodiment, the second anti-fall device 1009 also includes a cover plate 05 for the linkage plate 03. The cover plate 05 is equipped with limit holes, and the second pin 0105 rotates within the limit holes. The combination of the limit holes and the second pin 0105 forms the aforementioned limiting mechanism.

In one embodiment, the limit holes are constructed as following: when the main rotating shaft 0102 rotates to the limit position, the second pin 0105 engages with the inner wall of the limit holes in a limiting manner, and the rotation angle of the main rotating shaft 0102 is not greater than ninety degrees.

Certainly, in addition to the structure of limit holes and the second pin 0105, other structural forms can also be used for the limit mechanism, as long as they meet the limiting requirements for the main rotating shaft 0102. For example, the second wheel assembly 01 also includes a slider 0101, the slider 0101 is fixed on the main rotating shaft 0102, and the slider 0101 forms a mounting groove with the second pair wheels 0107; the limit mechanism includes the slider 0101 and the projection formed on the fixed main body 5; when the main rotating shaft 0102 rotates to the limit position, the slider 0101 engages in a limiting manner with the projection on the fixed main body 5.

When the second anti-fall device 1009 switches between two forms, the main rotation shaft 0102 rotates exactly ninety degrees. Certainly, if the rotation angle of the main rotation shaft 0102 is less than ninety degrees, it can still meet the disassembly requirements of the anti-fall device 1009, in this case, you can also limit the rotation angle of the main rotation shaft 0102 to a smaller value. Alternatively, it can also specify that the rotation angle of the main rotation shaft 0102 between the two extreme positions is greater than ninety degrees.

In FIGS. 24 to 28, the limiting hole includes the third limiting surface 0501 and the fourth limiting surface 0502. When rotating the main rotating member 0103, the main rotating shaft 0102 drives the second pin 0105 to rotate in the limiting hole. When the main rotating shaft 0102 rotates to the first limit position, the second pin 0105 contacts the third limiting surface 0501. When the main rotating shaft 0102 rotates to the second limit position, the second pin 0105 contacts the fourth limiting surface 0502. Through the coordination between the second pin 0105 and the third limiting surface 0501 and fourth limiting surface 0502, the anti-fall device 1009 can only switch between the two configurations shown in FIGS. 25 and 26.

In one embodiment, a first positioning groove 0601 is provided on the fixed main body 5, and a sliding pin 09 is set in the first positioning groove 0601. The main rotating shaft 0102 is equipped with a second positioning groove 01021 and a third positioning groove 01022. When the anti-fall device 1009 is inverted on the guide rail 006 and the main rotating shaft 0102 rotates to one of the extreme positions: the first positioning groove 0601 corresponds to the second positioning groove 01021, causing the sliding pin 09 to partially enter the second positioning groove 01021; when the anti-fall device 1009 is inverted on the guide rail 006 and the main rotating shaft 0102 rotates to the other extreme position, the first positioning groove 0601 corresponds to the third positioning groove 01022, causing the sliding pin 09 to partially enter the third positioning groove 01022.

When the second anti-fall device 1009 is normally installed, the sliding pin 09 is positioned in the first positioning groove 0601 of the fixed main body 5 under the influence of gravity. At this point, there is no connection between the sliding pin 09 and the main rotating shaft 0102, and it does not interfere with the movement of the main rotating shaft 0102. When the second anti-fall device 1009 is inverted, as shown in FIG. 24, in two different configurations, the first positioning groove 0601 corresponds to the second positioning groove 01021 and the third positioning groove 01022 on the main shaft respectively, and the sliding pin 09 partially enters the second positioning groove 01021 or the third positioning groove 01022 under the influence of gravity. At this point, the sliding pin 09 can prevent the main rotating shaft 0102 from rotating, preventing the second anti-fall device 1009 from being installed.

Please refer to FIGS. 24 to 28. According to the disclosed embodiment of the second anti-fall device 1009, it is provided with passive positioning holes 0603 and active positioning holes 0604 on the fixed main body 5. The fifth spring 0106, which has a reset function, is installed between the fixed main body 5 and the main rotating shaft 0102, and between the fixed main body 5 and the slave rotating shaft 0201. For the second wheel assembly 01, one end of the fifth spring 0106 is installed in the first reset hole 01023 on the main rotating shaft 0102, and the other end is installed in the active positioning hole 0604 on the fixed main body 5 and secures the main rotating shaft 0102 to the fixed main body 5. For the third wheel assembly 02, one end of the fifth spring 0106 is installed in the second reset hole 02011 on the slave rotating shaft 0201, and the other end is installed in the passive positioning hole 0603 on the fixed main body 5 and secures the slave rotating shaft 0201 to the fixed main body 5.

For the second wheel assembly 01, the slider 0101 is installed on the main rotating shaft 0102 through the installation shaft 0108, and the roller 0107 and positioning washer 0109 are mounted on the installation shaft 0108. For the third wheel assembly 02, the slider 0101 is installed on the from rotating shaft 0201 through the installation shaft 0108, and the roller 0107 and positioning washer 0109 are mounted on the installation shaft 0108.

According to the disclosed embodiment, please refer to FIGS. 16 to 28, providing an anti-fall system comprising a guide rail 006 and the second anti-fall device 1009 installed on the guide rail 006. Additionally, the second anti-fall device 1009 includes a hook 009 and a buffer device 0011.

Please refer to FIGS. 16 to 28, the guide rail 006 includes a slider channel 00601, a running limit surface 00602, an outer support surface 00603, an inner support surface 00604, and a guide rail support surface 00605. By rotating the main rotating member 0103, the second anti-fall device 1009 switches between the two states shown in FIGS. 17 and 19. When the second anti-fall device 1009 is in the state shown in FIG. 19, the second anti-fall device 1009 can be installed on or removed from the guide rail 006. When the second anti-fall device 1009 is in the state shown in FIG. 17, it can be fixed in the guide rail 006, with the slider 0101 positioned in the slider channel 00601 and moving along the slider channel 00601. Additionally, when the second anti-fall device 1009 is installed on the guide rail 006, the fifth limiting surface 505 on the fixed body 5 runs within the running limiting surface 00602 and by doing so, achieves horizontal orientation restriction for the second anti-fall device 1009. When the second anti-fall device 1009 is in motion, the outer support surface 00603 contacts the roller 0107 installed on the upper part of the fixed body 5, and the inner support surface 00604 contacts the roller 0107 installed on the running support slider 01012. When the second anti-fall device 1009 is locked, the outer support surface 00603 contacts the roller 0107 installed on the lower part of the fixed body 5, and the inner support surface 00604 contacts the roller 0107 installed on the locking support slider 01011.

In addition to the first wheel assembly 10, the fixed body 5 in this disclosed embodiment is fixed with four pairs of wheel assemblies. This includes the aforementioned second wheel assembly 01 and third wheel assembly 02 used to roll along the inner support surface 00604 of the guide rail 006. Additionally, there are two pairs of wheel assemblies used to roll along the outer support surface 00603 of the guide rail 006. These four pairs of wheel assemblies each include at least one pair of rollers 0107.

The above anti-fall system utilizes the first triggering mechanism 1 and the second triggering mechanism 2 to trigger the second locking member 3 for preventing the abnormal downward movement of the second anti-fall device 1009 relative to the guide rail 006. During the movement from the triggering position to the locking position, it interacts with the guide rail 006. One end of the buffering device 0011 is attached to the connection hole 201, and the other end is connected to the hook 009.

According to the disclosed embodiment, the carriage 1051 includes a pedal 10511, and a load detection component is installed on the pedal 10511, and the load detection component controls the start and stop of the carriage 1051 based on changes in the load on the pedal 10511. Specifically, when the operating personnel use the climbing assistant 1005, when the second anti-fall device 1009 is installed on the guide rail 006, if the operating personnel leave the pedal 10511, the load detection component detects the change in load, the carriage 1051 will immediately stop, ensuring the personal safety of the operating personnel and the safe use of the climbing assistant 1005. Alternatively, when the climbing assistant 1005 loses weight, the load detection component detects a change in the data, thereby controlling the carriage 1051 to stop.

In one embodiment, the load detection component controls the carriage 1051 to stop based on the load on the pedal 10511 being greater than a first set load or less than a second set load, where the first set load is greater than the second set load. In other words, when the load on the pedal 10511 is too high, indicating an overweight condition, the control system stops the carriage 1051 to ensure that the carriage 1051 cannot operate in an overweight condition. When the load on the pedal 10511 is very low, indicating that the load is less than the set weight of the operating personnel, it is recognized that there is a risk of personnel falling and control the carriage 1051 to stop. The term “control the carriage 1051 to stop” here includes the process of transitioning the carriage 1051 from motion to a stop, as well as maintaining the stopped state of the carriage 1051, preventing it from being restarted.

Finally, it should be noted that the above embodiments are only intended to illustrate the technical solutions disclosed herein and are not intended to limit them: although detailed descriptions have been provided in reference to the embodiments, those skilled in the art should understand that modifications can be made to the technical solutions described in the embodiments or some technical features can be equivalently replaced. Such modifications or replacements do not depart from the spirit and scope of the technical solutions disclosed in the various embodiments.

What is claimed is:

1. A lifting equipment comprises:
a guide rail;
a climbing assistant, suitable for ascending and descending along the rail, the said climbing assistant comprises a carriage and a first anti-fall device, the said first anti-fall device is installed between the said carriage and the said guide rail, and the said first anti-fall device is capable of locking onto the said guide rail when the said carriage loses weight;
a second anti-fall device, suitable for installation between the said guide rail and the personnel working on the said carriage, and the said second anti-fall device is capable of locking onto the same guide rail as the said climbing assistant when the personnel on the said carriage become weightless.

2. The lifting equipment according to claim 1, wherein the said guide rail includes a first sidewall and a third sidewall arranged in a relative configuration, and a second sidewall connecting the said first sidewall and the said third sidewall, a closing groove being formed between the said first sidewall, the said second sidewall and the said third sidewall, and the said closing groove is used for installing the said first anti-fall device and the said second anti-fall device.

3. The lifting equipment according to claim 2, wherein the said guide rail includes a connecting part, and the said connecting part is set with positioning holes, the said positioning holes on the adjacent sections of the said guide rail correspond to each other, and the connecting shafts are connected respectively at both ends to the said positioning holes of the adjacent sections of the said guide rail to fixedly connect the adjacent segments of the guide rail.

4. The lifting equipment according to claim 3, wherein the said connecting part includes protuberances formed respectively on the said first sidewall and the said third sidewall, and the said protuberances extend along the length of the said guide rail, and the said carriage includes guiding grooves that form a guiding coordination with the protuberances.

5. The lifting equipment according to claim 2, wherein the said first sidewall of adjacent sections of the said guide rail, as well as the said third sidewall of adjacent sections of the said guide rail, are all fixed by connecting members.

6. The lifting equipment according to claim 2, wherein the said second sidewall is formed with locking holes, and the said first anti-fall device and the said second anti-fall device are locked into the said locking holes.

7. The lifting equipment according to claim 1, wherein the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

8. The lifting equipment according to claim 2, wherein the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

9. The lifting equipment according to claim 3, wherein the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

10. The lifting equipment according to claim 4, wherein the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

11. The lifting equipment according to claim 5, wherein the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

12. The lifting equipment according to claim 6, wherein the said first anti-fall device includes a first anti-fall component, the said first anti-fall component comprises a tachometer wheel, a centrifugal block, and a first cam, the said centrifugal block is fixed with the said tachometer wheel and rotates with the said tachometer wheel, the said centrifugal block is configured to: when the rotational speed of the said tachometer wheel is not less than the set speed, the said centrifugal block opens and connects with the said first cam to drive the rotation of the said first cam.

13. The lifting equipment according to claim 7, wherein the said tachometer wheel and the said centrifugal block are both fixedly mounted on a main shaft, the said tachometer wheel drives the said rotation of the centrifugal block through the said main shaft, the said first cam is fixedly mounted on a transmission shaft, and when the said centrifugal block is open, it connects with the said transmission shaft through a transmission sleeve.

14. The lifting equipment according to claim 7, wherein the said first anti-fall device also includes a second anti-fall component, the said second anti-fall component comprises a first locking member hinged on the said carriage, when the said carriage is operating normally, the said first locking member compresses a reset spring, when the said carriage undergoes weightlessness, the said reset spring ejects the said first locking member, causing the said first locking member to lock onto the said guide rail.

15. The lifting equipment according to claim 1, wherein the said second anti-fall device includes:
a fixed main body, installed on the said guide rail through a first wheel assembly and moving along the said guide rail, wherein the said first wheel assembly includes a wheel shaft;
a locking member, installed on the said fixed main body, and capable of switching between a locked position and a free position;
a first triggering mechanism, installed on the said fixed main body, the said first triggering mechanism comprises a transmission component and a driving component, the said transmission component is mounted on the said wheel shaft and rotates with the said wheel shaft, the said transmission component switches between a first position and a second position based on centrifugal force, in the said first position, the said transmission component disengages from the said driving component, and in the said second position, the said transmission component transfers the rotation of the said wheel shaft to the said driving component, causing the said driving component to rotate and move the said locking member to the said locked position.

16. The lifting equipment according to claim 15, wherein the said second anti-fall device further includes:
a second triggering mechanism, installed on the said fixed main body, comprising an oscillating bar, the said oscillating bar switches between a reset position and a force-receiving position, in the said reset position, the said oscillating bar drives the said locking member to move to the said locked position.

17. The lifting equipment according to claim 16, wherein the said oscillating bar comprises a triggering end and a free end, the said triggering end is connected to the said fixed main body through a second elastic element, in the said reset position, the said second elastic element is in its original state, and in the said force-receiving position, the said second elastic element is compressed, the said free end forms a connecting hole, which is used to connect to the personnel working on the said carriage.

18. The lifting equipment according to claim 16, wherein the said second anti-fall device further includes:
a first wheel assembly, mounted on the said fixed main body, for rolling along the said guide rail;
a second wheel assembly, mounted on the said fixed main body, for rolling along an inner support surface of the said guide rail, the said second wheel assembly includes a second wheel pair, with the said second wheel pair connected to a main rotation shaft, the said main rotation shaft is connected to a main rotating element;
a third wheel assembly, mounted on the said fixed main body, for rolling along the said inner support surface of the said guide rail, the said third wheel assembly includes a third wheel pair, with the said third wheel pair connected to a slave rotation shaft;
a linkage component is set between the said main rotation shaft and the said slave rotation shaft.

19. The lifting equipment according to claim 1, wherein the said carriage includes a pedal, and the said pedal is set with a load detection component, the said load detection component controls the starting and stopping of the said carriage based on changes in the load on the said pedal.

20. The lifting equipment according to claim 19, wherein the said load detection component controls the stopping of the said carriage based on the load on the said pedal being greater than a first set load or less than a second set load, wherein the said first set load is greater than the said second set load.
